(19) United States
(12) Patent Application Publication
(10) Pub. No.: US 2020/0020000 A1
(43) Pub. Date: Jan. 16, 2020

(54) GENERATING PRODUCT DESCRIPTIONS FROM USER REVIEWS

(71) Applicant: eBay Inc., San Jose, CA (US)

(72) Inventors: Ido Guy, Haifa (IL); Kira Radinski, Zichron Yaakov (IL)

(21) Appl. No.: 16/036,110

(22) Filed: Jul. 16, 2018

(51) Int. Cl. G06Q 30/02; G06Q 30/06; G06F 17/24; G06F 17/28

(52) U.S. Cl. CPC G06Q 30/0282; G06F 17/2881; G06F 17/24; G06Q 30/0627

(57) ABSTRACT

Systems and methods of improving a user interface by generating product descriptions from user reviews are disclosed. In some example embodiments, a computer system identifies a subset of product review contents from amongst a plurality of product review contents as being suitable to be used in a product description for a product using a classifier, selects at least a portion of the identified subset of product review contents for inclusion in the product description for the product based on their corresponding confidence values, and causes the at least a portion of the identified subset of product review contents to be displayed on a client device in a user interface area dedicated for the product description of the product. The classifier predicts each product review content in the subset to be suitable to be used in the product description with a corresponding confidence value.

### TECHNICAL FIELD

Embodiments of the present disclosure relate generally to the technical field of electronic communications and, more particularly, but not by way of limitation, to systems and methods of improving user interfaces by generating product descriptions from user reviews.

### BACKGROUND

Limited availability of data can hinder the ability of a networked site (e.g., a website) to provide online services to its users and a lack of data can cause technical problems in the performance of the online services. For example, in situations where an online service is performing a search based on search criteria for a certain type of data, entities are often omitted from the search because of their lack of that type of data even though they would have satisfied the search criteria if someone had included the corresponding data for those entities. As a result, the accuracy and completeness of the search results are diminished. Additionally, since otherwise relevant search results are omitted, users often spend a longer time on their search, consuming electronic resources (e.g., network bandwidth, computational expense of server performing search). Users viewing user interfaces that lack certain types of data often waste time consuming electronic resources scrolling through the user interfaces in an unsuccessful attempt to find the missing data. Furthermore, the task of efficiently and effectively generating a certain type of data from another type of data is technically challenging, as many issues have to be addressed, including, but not limited to, efficient and effective parsing of data, and efficient and effective implementation of user interfaces presenting data on a computing device given the particular technical characteristics of the computing device. Other technical problems can arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a networked system, in accordance with some example embodiments.

FIG. 2 is a block diagram illustrating various components of a network-based publication system, in accordance with some example embodiments.

FIG. 3 is a block diagram illustrating various tables that can be maintained within a database, in accordance with some example embodiments.

FIG. 4 illustrates a graphical user interface (GUI) displaying a product listing including a first user interface area dedicated for a product description and a second user interface area dedicated for product reviews, in accordance with some example embodiments.

FIG. 5 is a block diagram illustrating components of a data generation system, in accordance with some example embodiments.

FIG. 6 illustrates a table of product review content and their corresponding predicted confidence values as to their suitability for use in a product description, in accordance with some example embodiments.

FIG. 7 illustrates a ranking of a subset of product review content identified as being suitable to be used in a product description, in accordance with some example embodiments.

FIG. 8 illustrates a GUI displaying a product listing including a product description generated based on product reviews, in accordance with some example embodiments.

FIG. 9 illustrates another GUI displaying a product listing including a product description generated based on product reviews, in accordance with some example embodiments.

FIG. 10 is a flowchart illustrating a method of generating a product description from product reviews, in accordance with some example embodiments.

FIG. 11 is a flowchart illustrating a method of selecting at least a portion of an identified subset of product review content for inclusion in a product description for a product, in accordance with some example embodiments.

FIG. 12 is a flowchart illustrating a method of generating a product description from product reviews, in accordance with some example embodiments.

FIG. 13 is a block diagram illustrating a mobile device, in accordance with some example embodiments.

FIG. 14 is a block diagram illustrating a representative software architecture, in accordance with some example embodiments.

FIG. 15 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

The present disclosure provides technical solutions for efficiently and effectively parsing a first type of user generated data to generate a second type of data. In some example embodiments, given a product and a set of reviews, a computer system generates a description for the product based on the set of reviews by employing a particular set of operations, which include, but are not limited to, any combination of one or more of identifying sentences within the reviews that are suitable for use as part of a products description, such as by using a machine-learned classifier that deems a sentence as suitable or not, ranking the sentences by their likelihood to be suitable, such as their corresponding prediction confidence scores determined by the machine-learned classifier, removing redundancies among the ranked sentences, such as based on similarity scores between sentences, and ordering the remaining sentences, or a selected portion of the remaining sentences, based on a model (e.g., some sentences may be more appropriate at the end of the description than at the beginning or the middle).

In some example embodiments, the generated description includes sentences that do not appear in their original form as they did in the reviews. For example, the computer system may use a translation model, which, upon receiving a review, identifies the sentences in the review that can be description candidates and transforms each of those identified sentences into a description sentence, thereby addressing the main reasons for which review sentences are sometimes not suitable for use in a product description: subjectivity, missing context, poor/bad language, or doubt expression. This transformation may include the removal of a certain word or a clause or their replacement with another word or clause. For example, words such as “however” that have a missing context, “probably” that express doubt, or clauses such as “I recommend”, “in my opinion”, and “to me” that express subjectivity can be removed.

Additionally, in some example embodiments, the computer system generates and configures a product description and a specific user interface for the product description based in part on one or more characteristics of the client device on which the product description is to be displayed. For example, a shorter description may be generated for display on a smartphone, whereas a larger description may be generated for display on a desktop computer.

Therefore, the features disclosed herein improve the functioning of a computer or other machine by at least efficiently and effectively parsing a first type of user generated data to generate a second type of data, efficiently and effectively implementing user interfaces presenting data on a computing device given the particular technical characteristics of the computing device, and reducing the consumption of electronic resources associated with a lack of available data (e.g., network bandwidth, computational expense of server performing search). Other improvements to the functioning of a computer or machine are also apparent from this disclosure.

In some example embodiments, operations are performed by a computer system or other machine having a memory and at least one hardware processor, with the operations comprising identifying a subset of product review contents from amongst a plurality of product review contents as being suitable to be used in a product description for a product using a classifier, selecting at least a portion of the identified subset of product review contents for inclusion in the product description for the product based on the corresponding confidence values of the selected at least a portion of the identified subset of product review contents, and causing the at least a portion of the identified subset of product review contents to be displayed on a client device in a user interface area dedicated for the product description of the product. In some example embodiments, the classifier predicts each product review content in the subset to be suitable to be used in the product description with a corresponding confidence value. In some example embodiments, each product review content in the plurality of product review contents comprises text-based data, such as a word, a clause, or a sentence. However, other types of product review content is also within the scope of the present disclosure.

In some example embodiments, the selecting the at least a portion of the identified subset of product review contents comprises ranking the subset of product review contents based on the confidence values of the subset of product review contents, and selecting the at least a portion of the identified subset of product review contents based on the ranking.

In some example embodiments, the selecting the at least a portion of the identified subset of product review contents further comprises determining that at least one of the product review contents in the subset of product review contents is to be omitted from inclusion in the selected portion of the identified subset of product review contents to be displayed in the user interface area dedicated for the product description of the product, and omitting the at least one of the product review contents from the selected portion of the identified subset of product review contents based on the determining that the at least one of the product review contents is to be omitted. In some example embodiments, the determining that the at least one of the product review contents in the subset of product review contents is to be omitted from inclusion is based on at least one factor. In some example embodiments, the factor(s) include, but are not limited to, a determination that the at least one of the product review contents in the subset of product review contents is redundant with respect to another product review content in the subset of product review contents, a determination that the at least one of the product review contents in the subset of product review contents comprises random characters or is otherwise unreadable, a determination that the at least one of the product review contents in the subset of product review contents is in the form of a particular language or not in the form of a particular language, and a determination that the at least one of the product review contents in the subset of product review contents was authored by a user from a particular geographical location or region or was authored by a user not from a particular geographical location or region.

In some example embodiments, the selecting the at least a portion of the identified subset of product review contents comprises determining that at least one of the product review contents in the subset of product review contents is redundant with respect to another product review content in the subset of product review contents based on a comparison of the at least one of the product review contents in the subset with other product review content in the subset, and omitting the at least one of the product review contents from the selected portion of the identified subset of product review contents based on the determination that the at least one of the product review content is redundant.

In some example embodiments, the selecting the at least a portion of the identified subset of product review contents comprises determining an order in which to display the at least a portion of the identified subset of product review contents based on a model, with the order being inconsistent with the ranking of the subset of product review contents.

In some example embodiments, the identifying the subset of product review contents comprises receiving a plurality of source sentences from product reviews, and translating each one of the plurality of source sentences into a corresponding target sentence using a translation model, the plurality of product review contents comprising the target sentences corresponding to the plurality of source sentences.

In some example embodiments, the selecting of the at least a portion of the identified subset of product review contents for inclusion in the product description for the product is based on at least one of: for each one of the plurality of source sentences and its corresponding target sentence, a degree of change between the source sentence and the target sentence; for each one of the plurality of source sentences and its corresponding target sentence, one or more words that were removed in the translating of the source sentence into the target sentence; for each one of the plurality of source sentences and its corresponding target sentence, one or more words that were added in the translating of the source sentence into the target sentence; and for each one of the plurality of source sentences and its corresponding target sentence, a confidence score for the translating of the source sentence into the target sentence.

In some example embodiments, the selecting of the at least a portion of the identified subset of product review contents is based on one or more characteristics of the client device. In some example embodiments, the one or more characteristics comprises a screen size of the client device.

In some example embodiments, the operations further comprise training the classifier using another plurality of product review contents as training data, with a portion of the other plurality of product review contents being identified as being suitable for use in product descriptions, and a remaining portion of the other plurality of product review contents being identified as being unsuitable for use in product descriptions.

The methods or embodiments disclosed herein can be implemented as a computer system having one or more modules (e.g., hardware modules or software modules). Such modules can be executed by one or more hardware processors of the computer system. The methods or embodiments disclosed herein can be embodied as instructions stored on a machine-readable medium that, when executed by one or more processors, cause the one or more processors to perform the instructions.

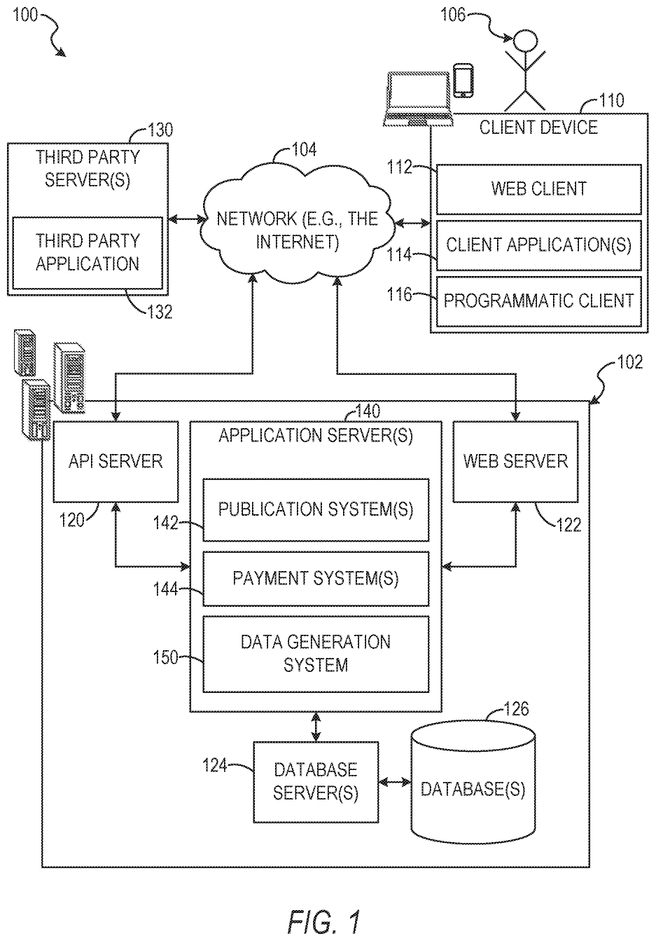

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application servers 140 may host one or more publication systems 142, payment systems 144, and data generation system 150, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The data generation system 150 provides functionality operable to perform various data generation operations, as will be discussed in further detail below. The data generation system 150 may access the data from the databases 126, the third party servers 130, the publication system 142, and other sources. In some example embodiments, the data generation system 150 may analyze the data to perform data generation operations. In some example embodiments, the data generation system 150 communicates with the publication systems 142 (e.g., accessing item listings) and payment system 144. In an alternative embodiment, the data generation system 150 is a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and data generation system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 132, executing on a third party server(s) 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

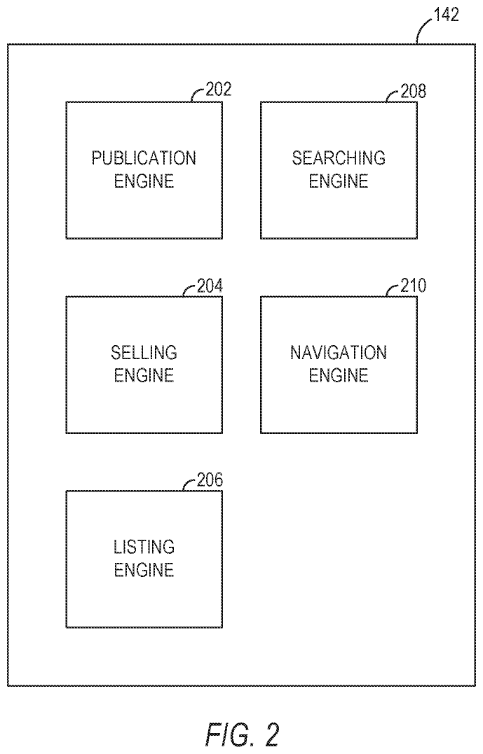

FIG. 2 is a block diagram illustrating various components of the network-based publication system 142, in accordance with some example embodiments. The publication system 142 can be hosted on dedicated or shared server machines that are communicatively coupled to enable communications between server machines. The components themselves are communicatively coupled (e.g., via appropriate interfaces) to each other and to various data sources, so as to allow information to be passed between the components or so as to allow the components to share and access common data. Furthermore, the components can access one or more databases 126 via the database servers 124.

The publication system 142 can provide a number of publishing, listing, and/or price-setting mechanisms whereby a seller (also referred to as a first user) can list (or publish information concerning) goods or services for sale or barter, a buyer (also referred to as a second user) can express interest in or indicate a desire to purchase or barter such goods or services, and a transaction (such as a trade) can be completed pertaining to the goods or services. To this end, the publication system 142 can comprise at least one publication engine 202 and one or more selling engines 204. The publication engine 202 can publish information, such as item listings or product description pages, on the publication system 142. In some embodiments, the selling engines 204 can comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines can also provide a number of features in support of these auction-format listings, such as a reserve price feature whereby a seller can specify a reserve price in connection with a listing and a proxy-bidding feature whereby a bidder can invoke automated proxy bidding. The selling engines 204 can further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the publication system 142. In some embodiments, the listings can be an offer, deal, coupon, or discount for the good or service. Each good or service is associated with a particular category. The listing engine 206 can receive listing data such as title, description, and aspect name/value pairs. Furthermore, each listing for a good or service can be assigned an item identifier. In other embodiments, a user can create a listing that is an advertisement or other form of information publication. The listing information can then be stored to one or more storage devices coupled to the publication system 142 (e.g., databases 126). Listings also can comprise product pages that display a product and information (e.g., product title, specifications, descriptions, and reviews) associated with the product. In some embodiments, the product page can include an aggregation of item listings that correspond to the product described on the product page.

The listing engine 206 can also allow buyers to conveniently author listings or requests for items desired to be purchased. In some embodiments, the listings can pertain to goods or services that a user (e.g., a buyer) wishes to transact via the publication system 142. Each good or service is associated with a particular category. The listing engine 206 can receive as much or as little listing data, such as title, description, and aspect name/value pairs, that the buyer is aware of about the requested item. In some embodiments, the listing engine 206 can parse the buyer's submitted item information and can complete incomplete portions of the listing. For example, if the buyer provides a brief description of a requested item, the listing engine 206 can parse the description, extract key terms, and use those terms to make a determination of the identity of the item. Using the determined item identity, the listing engine 206 can retrieve additional item details for inclusion in the buyer item request. In some embodiments, the listing engine 206 can assign an item identifier to each listing for a good or service.

In some embodiments, the listing engine 206 allows sellers to generate offers for discounts on products or services. The listing engine 206 can receive listing data, such as the product or service being offered, a price and/or discount for the product or service, a time period for which the offer is valid, and so forth. In some embodiments, the listing engine 206 permits sellers to generate offers from the sellers' mobile devices. The generated offers can be uploaded to the publication system 142 for storage and tracking.

Searching the publication system 142 is facilitated by a searching engine 208. For example, the searching engine 208 enables keyword queries of listings published via the publication system 142. In example embodiments, the searching engine 208 receives the keyword queries from a device of a user and conducts a review of the storage device storing the listing information. The review will enable compilation of a result set of listings that can be sorted and returned to the client device 110 of the user. The searching engine 208 can record the query (e.g., keywords) and any subsequent user actions and behaviors (e.g., navigations).

The searching engine 208 also can perform a search based on the location of the user. A user can access the searching engine 208 via a mobile device and generate a search query. Using the search query and the user's location, the searching engine 208 can return relevant search results for products, services, offers, auctions, and so forth to the user. The searching engine 208 can identify relevant search results both in a list form and graphically on a map. Selection of a graphical indicator on the map can provide additional details regarding the selected search result. In some embodiments, the user can specify as part of the search query a radius or distance from the user's current location to limit search results.

The searching engine 208 also can perform a search based on an image. The image can be taken from a camera or imaging component of a client device or can be accessed from storage.

In a further example, a navigation engine 210 allows users to navigate through various categories, catalogs, or inventory data structures according to which listings can be classified within the publication system 142. For example, the navigation engine 210 allows a user to successively navigate down a category tree comprising a hierarchy of categories (e.g., the category tree structure) until a particular set of listings is reached. Various other navigation applications within the navigation engine 210 can be provided to supplement the searching and browsing applications. The navigation engine 210 can record the various user actions (e.g., clicks) performed by the user in order to navigate down the category tree.

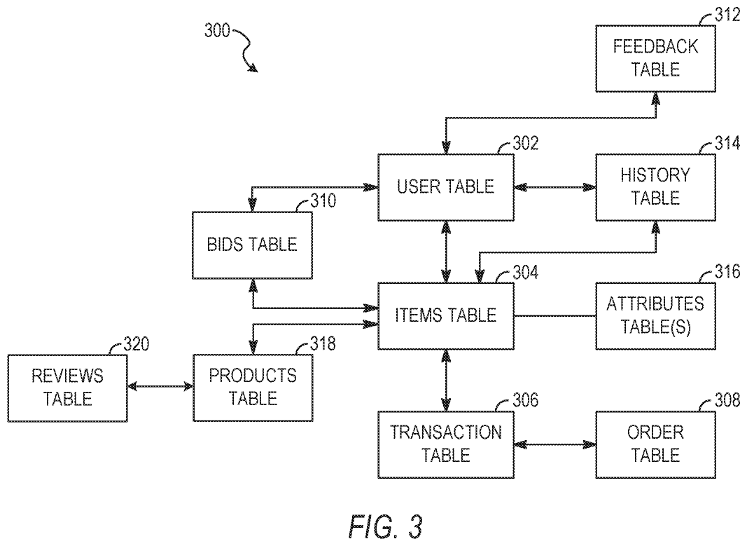

FIG. 3 is a high-level entity-relationship diagram, illustrating various tables 300 that can be maintained within the database(s) 126, and that are utilized by and support the systems 142, 144, and 150. A user table 302 contains a record for each registered user of the networked system 102, and can include identifier, address and financial instrument information pertaining to each such registered user. A user can operate as a seller, a buyer, or both, within the networked system 102. In one example embodiment, a buyer can be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 can furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, can be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 can indicate a currency attribute associated with a particular item, with the currency attribute identifying the currency of a price for the relevant item as specified by a seller.

In some example embodiments, the tables 300 also include a products table 318 in which are maintained product records for goods and services that are available to be, or have been, transacted via the networked system 102. Each product record within the products table 318 can furthermore be linked to one or more user records within the user table 302, so as to associate a seller and one or more actual or potential buyers with each item record. In some example embodiments, a reviews table 320 is utilized by one or more review applications, in one example embodiment, to construct and maintain reviews concerning products. Such product reviews can be authored and submitted by users and can include, but are not limited to, text-based information describing a user's experience with the corresponding product, as well as one or more user-submitted ratings of the product, such as one or more graphical user interface elements that represent a rating (e.g., a star-based ratings system).

In some example embodiments, the data generation system 150 is configured to aggregate, at a product identification (ID) level, product reviews entered and submitted for item listings, and then use those product reviews to generate a product description for the product ID. Product reviews are distinguished from seller reviews and buyers reviews in that product reviews are directed towards and meant to review a product, not a seller or a buyer. Accordingly, each product review can be associated in a database with a corresponding product (e.g., a corresponding product ID), such that all of the product reviews for a specific product can be aggregated and displayed in response to a request for product reviews for that specific product, as opposed to a request for reviews of a seller or a buyer.

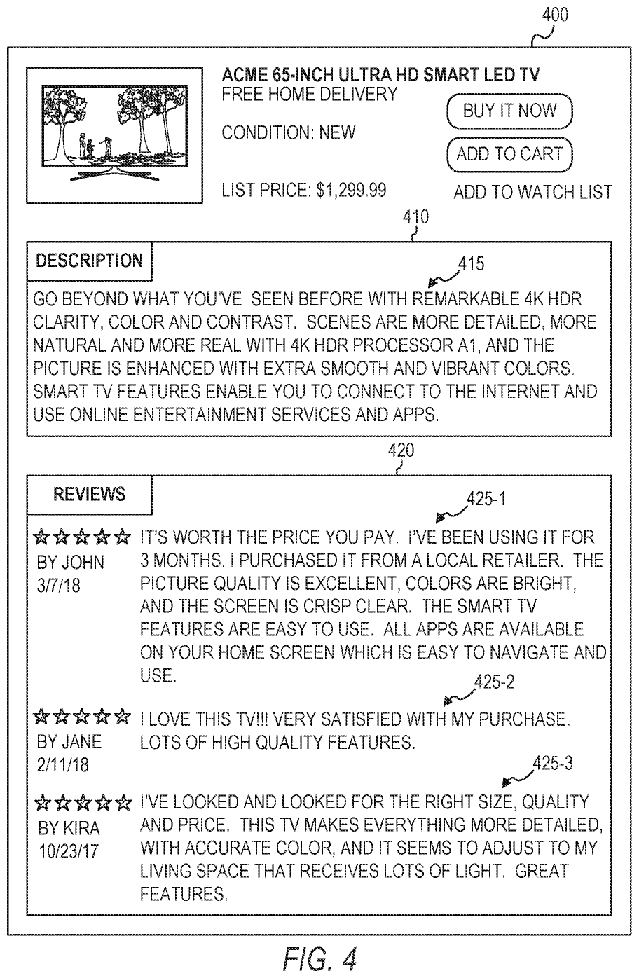

FIG. 4 illustrates a graphical user interface (GUI) 400 displaying a product listing for a product (e.g., “ACME 65-INCH ULTRA HD SMART LED TV”). The GUI 400 includes a first user interface area 410 dedicated to or for a product description 415 and a separate second user interface area 420 dedicated to or for product reviews 425, in accordance with some example embodiments. In the example shown in FIG. 4, the second user interface area 420 includes three product reviews 425 (425-1, 425-2, and 425-3). Each one of the product reviews 425 comprises or is defined by a plurality of product review content. The product review content comprises text-based information describing a user's experience with the corresponding product. Examples of text-based information include, but are not limited to, words, clauses, and sentences. The product reviews 425 are authored and submitted by customer users of the product, such as users that have purchased and used the product, and the product reviews 425 are maintained in one or more databases of an online service, such as in the reviews table 320 of FIG. 3.

The product description 415 is different from the product reviews 425 in that the product description 415 is authored and submitted by an administrative user of the networked system 102 on which the product is listed. The administrative user is different from the customer users in that the administrative user has the authority and ability to enter and edit information for certain aspects of the product listing that the customer users are not authorized or able to enter or edit. Examples of administrative users include, but are not limited to, a seller of the product and an authorized employee of the networked system 102 on which the product listing is published. The product description 415 comprises text-based information that describes the product in a more objective way than the product reviews and in a way that is more generalized than just the specific experience of a specific customer user.

In addition to the product description 415 and the product reviews 425 being authored and submitted by different types of users and having different types of content, the product description 415 and the product reviews 425 are authored and submitted for storage using two different process flows and user interface flows. The product description 415 is authored and submitted using a listing creation process flow when the administrative user is creating the product listing for publication on the networked system 102 or using a listing editing process flow when the administrative user is editing the product listing. The product review 425 is authored and submitted using a review submission process flow using a user interface for authoring and submitting product reviews. The user interface that is used to author and submit product reviews is different from the user interface that is used to author, submit, and edit product descriptions.

Product descriptions 415 play a key role in connecting different users of the networked system 102, such as by enabling a user to find a product listing of another user by performing a search on a keyword that is included in the product description 415 of the product listing. However, many products lack a product description 415. Increasing the portion of high-quality descriptions can help improve the user experience on the product page, help match future listings to the product, and improve search engine optimization, search, and recommendations through more textual information that is highly relevant for the product.

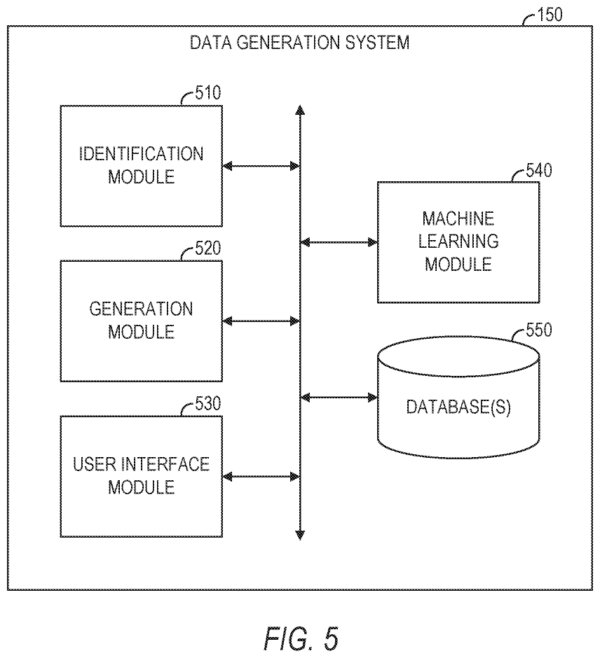

In some example embodiments, a computer system uses product reviews 425 for a product, which are often abundant for catalog products, to automatically generate a product description 415 for the product. FIG. 5 is a block diagram illustrating components of the data generation system 150, in accordance with some example embodiments. The data generation system 150 is configured to perform the operations and implement the features disclosed herein with respect to using product reviews 425 for a product to automatically generate a product description 415 for the product.

In some example embodiments, the data generation system 150 comprises any combination of one or more of an identification module 510, a generation module 520, a user interface module 530, a machine learning module 540, and one or more databases 550. The modules 510, 520, 530, 540, and the database(s) 550 are communicatively coupled to each other. In some example embodiments, the modules 510, 520, 530, 540 and the database(s) 550 reside on a single machine having a memory and at least one hardware processor. In some example embodiments, one or more of the modules 510, 520, 530, 540, and the database(s) 550 reside on different machines. Database(s) 550, or a portion thereof, can be incorporated into the database(s) 126 of FIG. 1.

Identification of sentences or other product review content from product reviews that are suitable for product descriptions is different from summarizing product reviews, and is more technically challenging to implement, as it is a fundamentally different task that requires different techniques and evaluation than summarization methods. For example, if a sentence “I liked it very much” appears on many reviews, it should probably be included in any summary of this set of reviews. By contrast, such a sentence is not going to fit a product description and should not be selected. Product reviews often contain a strong personal sentiment on behalf of the users that authored and submitted them. This subjective sentiment creates a technical challenge in efficiently and effectively parsing product review contents to make sure they are suitable for use in a product description.

In some example embodiments, the identification module 510 is configured to identify a subset of product review contents from amongst a plurality of product review contents as being suitable to be used in a product description for a product using a classifier. The classifier determines whether a product review content is suitable for use in a product description. In some example embodiments, the classifier generates a confidence value for this determination. For example, the higher the confidence value generated by the classifier, the higher the probability that the product review content is suitable for use in a product description.

The classifier may use a confidence value threshold to identify the subset of product review content as being suitable to be used in the product description for the product. For example, the classifier may use a confidence value threshold of 0.6, such that any product review content having a corresponding confidence value of 0.6 or higher is classified as being suitable to be used in the product description, and any product review content having a corresponding confidence value less than 0.6 is classified as not being suitable to be used in the product description.

In some example embodiments, the identification module 510 extracts the plurality of product review contents from product reviews stored in association with the product for which a product description is being generated by the data generation system 150. For example, the identification module 510 may retrieve the product review contents from the reviews table 320 in FIG. 3 or some other data source of the networked system 102, which may be incorporated into the database(s) 550. In some example embodiments, each product review content comprises text-based content, such as one or more words, clauses, or sentences. However, other types of product review content are also within the scope of the present disclosure.

In some example embodiments, the machine learning module 540 is configured to train the classifier using a plurality of product review contents as training data. The product review contents being used as training data may be extracted from the reviews table 320 in FIG. 3 or some other data source of the networked system 102, which may be incorporated into the database(s) 550. In some example embodiments, a certain portion of the product review contents in the training data are labeled, tagged, or otherwise identified as being suitable for use in product descriptions, and a remaining portion of the product review contents in the training data are labeled, tagged, or otherwise identified as being unsuitable for use in product descriptions. The machine learning module 540 may perform one or more machine learning operations to train the classifier using the training data. In some example embodiments, a separate classifier is trained and used for each category of products. For example, one classifier may be trained and used for a fashion product category, while another classifier may be trained and used for an electronics product category. In some example embodiments, the machine learning module 540 trains a classifier for a particular product category using product reviews from that particular product category as training data, and the identification module 510 uses that classifier for that particular product category in identifying a subset of product review contents from amongst a plurality of product review contents as being suitable to be used in a product description for a product that corresponds to that particular product category.

In some example embodiments, the machine learning module 540 performs training on a balanced dataset, using any combination of one or more training techniques, including, but not limited to, under/over sampling and tuning the penalty parameter (e.g., as in support vector machines). The machine learning module 540 may also increase the number of positive examples used for training by taking actual sentences from product descriptions of products or using review sentences that are similar to these sentences. The machine learning module 540 can then train a binary classifier for the specific product category, which deems a sentence as positive (e.g., suitable for use in the product description) or not based on textual features (e.g., unigrams, bigrams, trigrams), surface features of the text (e.g., sentence length, punctuation), part of speech tags, resemblance to the language model of a target set of product descriptions, sentiment analysis score, and also features of the review and the reviewer (e.g., review length, position of the sentence in the review, rating of the review, number of votes the review received, the reputation score of the reviewer, the number of reviews they have posted on the site and within the product category).

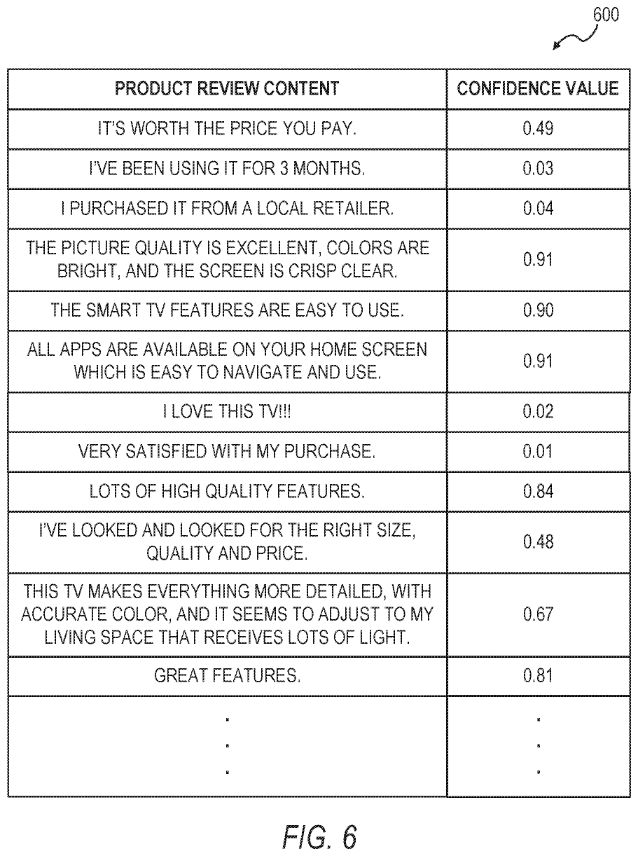

FIG. 6 illustrates a table 600 of product review contents and their corresponding predicted confidence values as to their suitability for use in a product description, in accordance with some example embodiments. In the example shown in FIG. 6, the product review contents in the table 600 are extracted from the product reviews 425-1, 425-2, and 425-3 in FIG. 4. As seen in the table 600, sentences that are highly personal sentiments have lower confidence values than sentences that are less personalized. For example, the product review content “THE PICTURE QUALITY IS EXCELLENT, COLORS ARE BRIGHT, AND THE SCREEN IS CRISP CLEAR” has a confidence value of 0.91, indicating that it is highly suitable for use in a product description, while the product review content “I'VE BEEN USING IT FOR 3 MONTHS” has a much lower confidence value of 0.03, indicating that it is highly unsuitable for use in a product description.

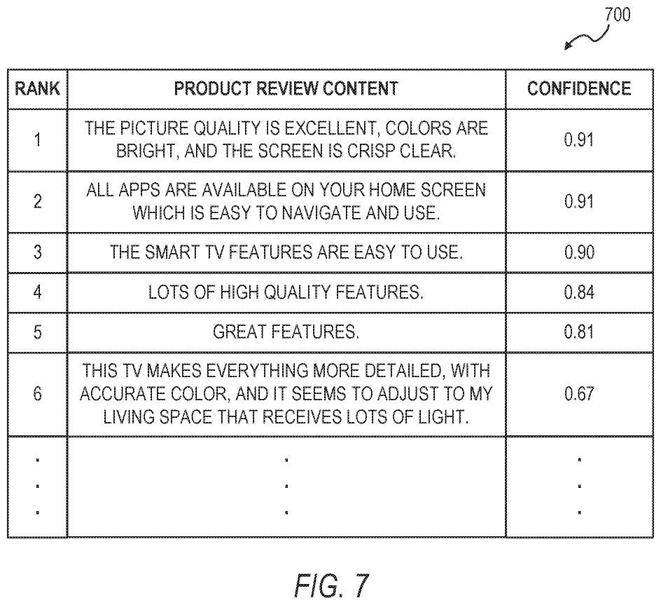

In some example embodiments, the generation module 520 is configured to select at least a portion of the identified subset of product review contents for inclusion in the product description for the product based on their corresponding confidence values. For example, the generation module 520 may rank the subset of product review content based on their corresponding confidence values, and then select the portion of the identified subset of product review content based on the ranking. FIG. 7 illustrates a ranking 700 of the subset of product review contents identified as being suitable to be used in the product description, in accordance with some example embodiments. The ranking 700 is based on the information in table 600 in FIG. 6. In some example embodiments, the generation module 520 selects the product review contents having the N highest confidence values among the plurality of product review contents, where N is a positive integer. For example, the generation module 520 may select the top three ranked product review contents for inclusion in the product description, which, in the example shown in FIG. 7, would result in the selection of the following three product review contents: (1) THE PICTURE QUALITY IS EXCELLENT, COLORS ARE BRIGHT, AND THE SCREEN IS CRISP CLEAR; (2) ALL APPS ARE AVAILABLE ON YOUR HOME SCREEN WHICH IS EASY TO NAVIGATE AND USE; and (3) THE SMART TV FEATURES ARE EASY TO USE.

In some example embodiments, the ranking of the product review contents is also based on one or more other features other than just their corresponding confidence values. Such factors include, but are not limited to, the number of reviews the product review content appeared in (e.g., the higher the number of reviews the product review content appeared in, the more positively the ranking of the product review content is affected), accumulated features of the reviews the product review content appeared in (e.g., the more positively the product review content is rated by other users, the more positively the ranking of the product review content is affected), and the accumulated features of the reviewers who authored and submitted the product review content (e.g., the more positively the user who authored the product review content is rated by other users, the more positively the ranking of the product review is content is affected). In this respect, the ranking of a particular product review content may be increased or decreased based on these additional features.

In some example embodiments, the generation module 520 is configured to use a confidence value threshold to filter out from selection any product review content that has a confidence value that does not meet the confidence value threshold. For example, the generation module 520 may require that a product review content have a confidence value of 0.91 or higher in order to be used in the product description. Using the examples shown in FIGS. 6 and 7, such a confidence value threshold of 0.91 causes the omission of the product review content “THE SMART TV FEATURES ARE EASY TO USE” due to the fact that the confidence value of that product review content is only 0.90, which is below the example confidence value threshold of 0.91.

In some example embodiments, the generation module 520 is configured to enforce diversification in the generated product description by using redundancy removal. In some example embodiments, the generation module 520 is configured to determine that one of the product review contents in the subset of product review contents is redundant with respect to another product review content in the subset of product review contents based on a comparison of the one of the product review contents in the subset with the other product review contents in the subset, and then omit the one of the product review contents from the selected portion of the identified subset of product review contents based on the determination that the one of the product review contents is redundant.

The determination of redundancy may be based on a similarity score generated by the generation module 520. In some example embodiments, the generation module 520 determines the similarity score based on word embeddings trained specifically on product reviews for the same product category or vertical (e.g., Fashion). Then, the generation module 520 applies a linear interpolation of the word order and the semantic similarity between the sentences as measured based on their embeddings. This method was found most effective for measuring review sentence similarity when compared against other alternatives, such as direct cosine similarity between the term frequency-inverse document frequency (TF-IDF) vectors of the sentence words. In some example embodiments, the generation module 520 then goes over the sentences according to their ranking and removes each sentence that is too similar to a preceding sentence in the ranking, using a similarity threshold. The similarity threshold may be established by measuring the minimum similarity between sentences in target product descriptions (e.g., product descriptions that are determined to be ideal) or by defining another annotation task that deems two sentences as too similar to be included in the same description or not.

In some example embodiments, the redundancy removal process is terminated when the generation module 520 determines that it has enough product review contents (e.g., sentences) for a product description. For example, a maximum number of characters, words, or sentences for a product description can be input as a parameter to the generation module 520, which may then work its way down the ranking of product review contents, removing redundancies, until the product review contents that have been passed through the redundancy removal process and survived meet the maximum number of characters, words, or sentences. This technical solution improves the functioning of the computer system by making its parsing of the product review content and generation of a product description for efficient and effective.

In some example embodiments, the generation module 520 is configured to use one or more other factors other than redundancy to omit a product review content in the subset of product review contents from inclusion in the selected portion of the identified subset of product review contents to be displayed in the user interface area dedicated for the product description of the product. In some example embodiments, the generation module 520 is configured to determine that at least one of the product review contents in the subset of product review contents is to be omitted from inclusion in the selected portion of the identified subset of product review contents to be displayed in the user interface area dedicated for the product description of the product, and omits the at least one of the product review contents from the selected portion of the identified subset of product review contents based on the determining that the at least one of the product review contents is to be omitted. In some example embodiments, the determining that the at least one of the product review contents in the subset of product review contents is to be omitted from inclusion is based on at least one factor. One of these factors may include redundancy, as previously discussed. However, other factors may include, but are not limited to, a determination that the at least one of the product review contents in the subset of product review contents comprises random characters or is otherwise unreadable, a determination that the at least one of the product review contents in the subset of product review contents is in the form of a particular language or not in the form of a particular language, and a determination that the at least one of the product review contents in the subset of product review contents was authored by a user from a particular geographical location or region or was authored by a user not from a particular geographical location or region.

In some example embodiments, the generation module 510 is configured to omit the at least one of the product review contents in the subset of product review contents from inclusion in the user interface area dedicated for the product description of the product based on a determination that the at least one of the product review contents in the subset of product review contents comprises random characters or is otherwise unreadable. For example, if the at least one of the product review contents in the subset of product review contents comprises text reading “FDEQ%L9#8 c3@&?,” then the generation module 520 may determine that the product review content comprises random characters or unreadable content, and therefore determines that the product review content is to be omitted from inclusion in the user interface area dedicated for the product description of the product.

In some example embodiments, the generation module 520 is configured to omit the at least one of the product review contents in the subset of product review contents from inclusion in the user interface area dedicated for the product description of the product based on a determination that the at least one of the product review contents in the subset of product review contents is in the form of a particular language or not in the form of a particular language. For example, the generation module 520 may require that product review content be in one or more specified languages (e.g., English) in order to be included in the user interface area dedicated for the product description of the product, and may omit any product review content determined to be in a language other than the specified language(s). Additionally or alternatively, the generation module 520 may omit a product review content from being included in the user interface area dedicated for the product description of the product based on a determination that the product review content is in the form of one or more specified languages. For example, the generation module 520 may be configured to omit any product review content that is determined to be in Russian or some other specified language. In some example embodiments, the generation module 520 determines which languages to require or restrict based on the corresponding country or other geographical location in which the product description will be published. For example, for a particular product that has corresponding product listings on a United States website and a Canadian website, the generation module 520 may require that the product review content to be used in the product description for the product listing on the United States website be in either English or Spanish, while the generation module 520 may require that the product review content to be used in the product description for the product listing on the Canadian website be in either English or French. By omitting product review content that does not satisfy such language-based criteria, the generation module 520 improves the personalization and relevancy of the product review content for a particular user.

In some example embodiment, the generation module 520 is configured to omit the at least one of the product review contents in the subset of product review contents from inclusion in the user interface area dedicated for the product description of the product based on a determination that the at least one of the product review contents in the subset of product review contents was authored by a user from a particular geographical location or region or was authored by a user not from a particular geographical location or region. For example, the generation module 520 may determine a geolocation associated with a product review content or an author of the product review content, such as by accessing such geolocation information from a database on which the product review content is stored. The generation module 520 may then determine whether the geolocation associated with the product review content or the author of the product review content satisfies a location criteria, and then omit the product review content from inclusion in the product description for the product based on a determination that the geolocation of the product review content does not satisfy the location criteria. For example, the generation module 520 may require that the geolocation of the product review content be within one or more specified states in order to be included in the user interface area dedicated for the product description of the product, and may omit any product review content determined to have a geolocation outside of the specified state(s). By omitting product review content that does not satisfy such location-based criteria, the generation module 520 improves the personalization and relevancy of the product review content for a particular user. Such location-based criteria may be specific to particular categories of products. For example, product review content for an air conditioning unit authored by a user in Arizona may be more relevant and useful than product review content for the air conditioning unit authored by a user in Alaska.

It is contemplated that other types of factors not specified above may be used by the generation module 520 in omitting product review content from inclusion in the product description of the product.

Some product review content from reviews are more suitable to be used at a particular position within the product description. Certain product review contents are more suitable to be used at the beginning of the product description rather than in the middle or at the end of the product description. Certain product review contents are more suitable to be used in the middle of the product description rather than at the beginning of the product description or at the end of the product description. Certain product review contents are more suitable to be used at the end of the product description rather than at the beginning of the product description or in the middle of the product description. For example, short positive sentences may be especially suitable at the end of a product description. Additionally, if connectors are included in the beginning of a sentence (e.g., “moreover”, “however”), the previous sentence should be appropriately related (e.g., either support or contrast the following sentence, respectively).

In some example embodiments, the generation module 520 is configured to determine an order in which to display the selected portion of the identified subset of product review contents based on a model. The order may be inconsistent with the confidence values of the subset of product review content, such that the selected product review contents are not ordered strictly according to their confident values. For example, although a set of product review contents A, B, and C may be ranked by their corresponding confidence values from the highest confidence score to the lowest confidence score in the order A, B, and C, and they may all be selected for inclusion in the product description based on their ranking, the generation module 520 may determine, based on an analysis of A, B, and C, that product review content B is more appropriately suited for placement at the beginning of the product description, product review content A is more appropriately suited for placement at the end of the product description, and product review content C is more appropriately suited for placement in the middle of the product description, resulting in a placement order of B, C, A in the product description.

In some example embodiments, the generation module 520 first identifies the sentences that require special treatment (e.g., placed in a certain position, be preceded by a supporting/contrasting sentence) and then attempts to fulfill these constraints according to their ranking. When a constraint cannot be fulfilled (e.g., there is already another sentence placed at the end of the description, or there is no contrasting sentence left among the candidates that can precede the sentence), the sentence may be excluded from consideration for inclusion in the product description.

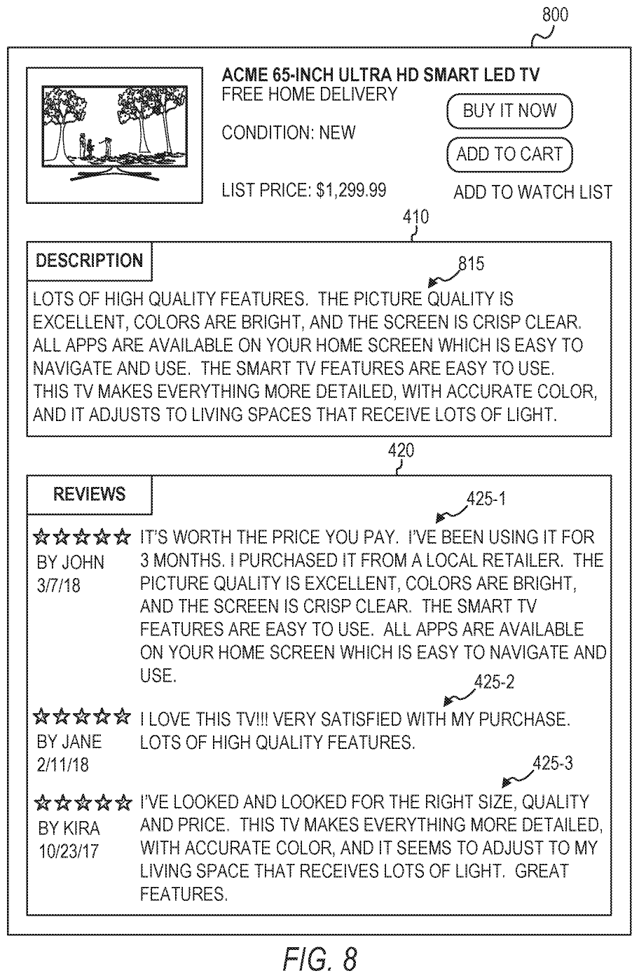

In some example embodiments, the user interface module 530 is configured to cause the selected portion of the identified subset of product review contents to be displayed on a client device in the user interface area 410 dedicated for the product description of the product. FIG. 8 illustrates a GUI 800 displaying a product listing including a product description 815 generated based on the product reviews 425, in accordance with some example embodiments. In FIG. 8, the product description 815 generated based on the product reviews 425 is displayed in the user interface area 410 dedicated for the product description of the product. Furthermore, in the example shown in FIG. 8, the generation module 520 originally selected the top five highest ranking product review contents from table 700 for inclusion in product description 815, but then removed the product review content included in the generated product description 815 corresponding to the product review content “GREAT FEATURES” based on the redundancy removal process because it was determined to be too similar to the higher-ranked product review content “LOTS OF HIGH QUALITY FEATURES,” thereby causing the next highest ranked product review content “THIS TV MAKES EVERYTHING MORE DETAILED . . . ” to be included in the generated product description 815. Additionally, in the example shown in FIG. 8, the selected product review contents are displayed in an order that does not completely correspond to their ranking. For example, the product review content “LOTS OF HIGH QUALITY FEATURES” is displayed at the beginning of the generated product description 815, even though it is not the top ranked product review content with the highest confidence value.

In some example embodiments, the order and interleaving of the ranking process, the redundancy removal process, and the ordering process discussed above may be modified. For example, the similarity score used in the redundancy removal process can be used to cluster the plurality of product review content, and then the cluster size can be used as a feature for ranking the clusters and selecting one representative product review content per cluster. Additionally, the ranking process may consider ordering constraints, such that a product review content that can be used anywhere in the product description gets boosted in the ranking compared to a product review content that can only be at the beginning or at the end of the product description.

In some example embodiments, the generated product description includes one or more product review contents that do not appear in their original form used in the product reviews. Using this approach may involve a change in the algorithm used for product review content classification by the identification module 510, and may influence the ranking of the product review contents by adding features. For the product review content classification, each product review content is not evaluated by the classifier as a candidate necessarily “as is”, but rather may be transformed into a modified product review content (e.g., a new sentence) that is more suitable for use in the product description, thereby enabling the identification module 510 to overcome various issues that overrule a potentially good product review content from being used as part of the generated product description.

In some example embodiments, the identification module 510 is configured to receive a plurality of source sentences from product reviews, and to translate or transform each one of the plurality of source sentences into a corresponding target sentence using a translation model. The target sentences are then used as the plurality of product review content that is processed by the identification module 510 in identifying the subset of product review contents from amongst the plurality of product review contents as being suitable to be used in the product description for the product using the classifier. Referring to FIGS. 7 and 8, the product review content “THIS TV MAKES EVERYTHING MORE DETAILED, WITH ACCURATE COLOR, AND IT SEEMS TO ADJUST TO MY LIVING SPACE THAT RECEIVES LOTS OF LIGHT” in table 700 in FIG. 7 is translated into “THIS TV MAKES EVERYTHING MORE DETAILED, WITH ACCURATE COLOR, AND IT ADJUSTS TO LIVING SPACES THAT RECEIVE LOTS OF LIGHT” used in the product description 815 in FIG. 8.

In some example embodiments, a rule-based system is used to transform the source sentences. Such rules address the main reasons for which product review sentences are not suitable for the product description, including, but not limited to, subjectivity, missing context, poor/bad language, and doubt expression. In some example embodiments, the rules include the removal of a certain word or a clause or their replacement with another word/clause. For example, words such as “however” (missing context), “probably” (doubt), or clauses such as “I recommend”, “in my opinion”, “to me” may be removed. Changes may include spelling correction such as “accomodate” to “accommodate” or “my son” to “you”. Examples of product review sentences (source sentences) being transformed into description sentences (target sentences) include:
a) Source: “My husband can use it both for walking and running” Target: “You can use it both for walking and running”
b) Source: “However, it can also be used when watching television, I think” Target: “It can also be used when watching television”

In some example embodiments, machine translation (MT) operations are used to generate the new sentences. As training data, the identification module 510 receives a pair of sentences—a product review sentence (source language) and a product description sentence (target language)—and applies MT operations to learn how to translate sentences from the source to the target language. The pair of sentences for training can be produced in two ways: 1) manual annotation: the annotators traverse the sentences in the reviews, and, for each sentence that can be suitable to a description, they create the appropriate description sentence that can be produced from it; and 2) automatically locating similar sentences in a set of reviews and a set of descriptions for the same product, using a sentence similarity measure as previously described. This second approach can generate a larger amount of training data, but noisier. After creating the translation model (either by rules or using automatic MT), the identification module 510, upon receiving a product review, identifies the sentences that can be product description candidates and transforms each of them, using the translation model, into product review content to be processed by the identification module 510 in identifying the subset of product review contents from amongst the plurality of product review contents as being suitable to be used in the product description for the product using the classifier.

The ranking process may be performed as discussed above, using learning to rank techniques, but the features of a sentence may now also refer to the transformation/translation that was performed by the identification module 510. For example, the ranking of the product review sentences (or other product review content) may be based on one or more of the following features: a degree of change between the source sentence and the target sentence (e.g., the number of changes used to create the target sentence from the source sentence, the “edit distance” by words), the words that were removed or added in the translating of the source sentence into the target sentence, a difference/ratio in lengths between the target sentence and the source sentence, and a confidence score for the translating of the source sentence into the target sentence.

Different client devices have different technical characteristics and capabilities. For example, certain client devices, such as smart phones and smart watches, have small display screens as compared to other client devices, such as desktop and laptop computers. As a result, the user interface area available for display of a product description is more limited on certain client devices than on others. The data generation system 150 may generate a special user interface for display of the generated product description based on the technical characteristics, aspects, or features of the client device. In some example embodiments, the selecting of the portion of the identified subset of product review contents is based on one or more characteristics of the client device on which the generated product description is to be displayed. In some example embodiments, the one or more characteristics comprises one or more of a screen size of the client device, a device type of the client device (e.g., smartwatch, smartphone, tablet computer, laptop computer, desktop computer), and a type of processor of the client device. However, it is contemplated that other types of characteristics are also within the scope of the present disclosure.

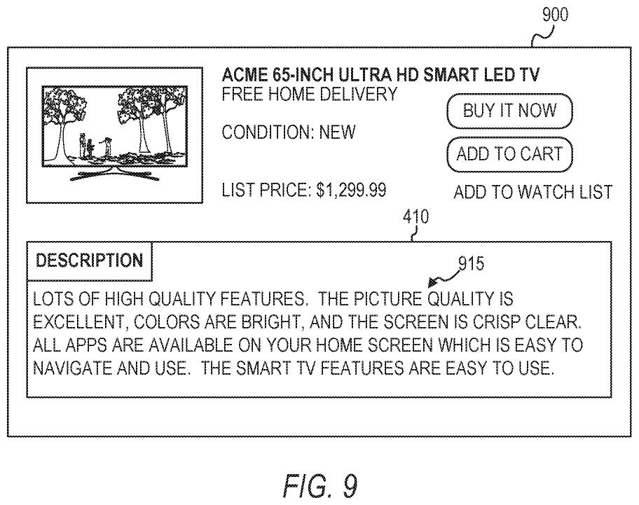

FIG. 9 illustrates another GUI 900 displaying a product listing including a product description 915 generated based on product reviews, in accordance with some example embodiments. In one example, the client device on which the GUI 900 including the product description 915 is displayed has different technical characteristics than the client device on which the GUI 800 including the product description 815 is displayed in FIG. 8. As a result, the data generation system 150 configures the generated product descriptions 815 and 915 differently. For example, the client device on which the product description 915 in FIG. 9 is displayed may have a significantly smaller display screen than the client device on which the product description 815 in FIG. 8 is displayed. As a result, the data generation system 150 omits the product review content “THIS TV MAKES EVERYTHING MORE DETAILED, WITH ACCURATE COLOR, AND IT ADJUSTS TO LIVING SPACES THAT RECEIVE LOTS OF LIGHT” from inclusion in the generated product description 915 in FIG. 9.

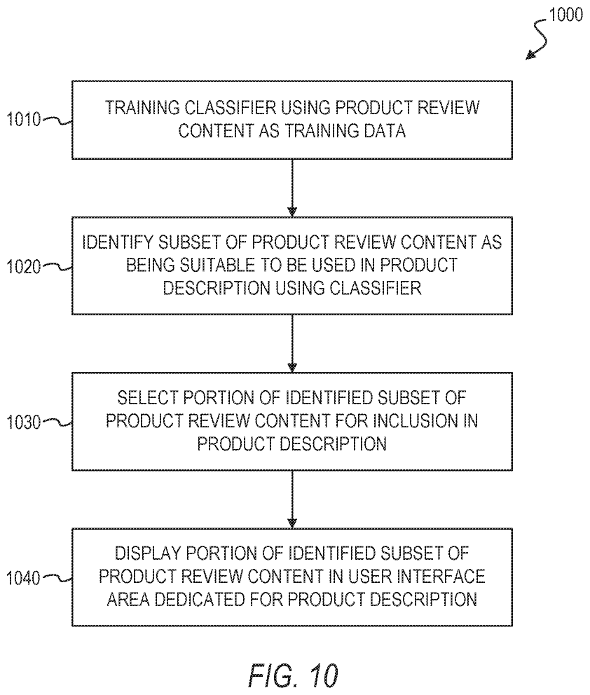

FIG. 10 is a flowchart illustrating a method 1000 of generating a product description from product reviews, in accordance with some example embodiments. The operations of method 1000 can be performed by a system or modules of a system. The operations of method 1000 can be performed by processing logic that can comprise hardware (e.g., circuitry, dedicated logic, programmable logic, microcode, etc.), software (e.g., instructions run on a processing device), or a combination thereof. In one example embodiment, the method 1000 is performed by data generation system 150 of FIGS. 1 and 5, or any combination of one or more of its components or modules, as described above.

At operation 1010, the data generation system 150 trains a classifier to determine whether a product review content is suitable for use in a product description. In some example embodiments, the classifier generates a confidence value for this determination. For example, the higher the confidence value generated by the classifier, the higher the probability that the product review content is suitable for use in a product description. In some example embodiments, the data generation system 150 trains the classifier using a plurality of product review contents as training data. The product review content being used as training data may be extracted from the reviews table 320 in FIG. 3 or some other data source of the networked system 102. A certain portion of the product review contents in the training data are labeled, tagged, or otherwise identified as being suitable for use in product descriptions, and a remaining portion of the product review contents in the training data are labeled, tagged, or otherwise identified as being unsuitable for use in product descriptions. In some example embodiments, the data generation system 150 performs one or more machine learning operations to train the classifier using the training data.

At operation 1020, the data generation system 150 identifies a subset of product review contents from amongst a plurality of product review contents as being suitable to be used in a product description for a product using the classifier. In some example embodiments, the classifier predicts each product review content in the subset to be suitable to be used in the product description with a corresponding confidence value, as discussed above with respect to the identification module 510 and shown in the table 600 in FIG. 6. The classifier may use a confidence value threshold to identify the subset of product review contents as being suitable to be used in the product description for the product. For example, the classifier may use a confidence value threshold of 0.6, such that any product review content having a corresponding confidence value of 0.6 or higher is classified as being suitable to be used in the product description, and any product review content having a corresponding confidence value less than 0.6 is classified as not being suitable to be used in the product description. In some example embodiments, each product review content in the plurality of product review contents comprises text-based content, such as one or more words, clauses, or sentences. However, other types of product review content are also within the scope of the present disclosure.

At operation 1030, the data generation system 150 selects at least a portion of the identified subset of product review contents for inclusion in the product description for the product. In some example embodiments, the data generation system 150 selects the portion of the identified subset of product review contents based on the corresponding confidence values generated by the classifier for the plurality of product review contents. For example, the data generation system 150 may select the product review contents having the N highest confidence values among the plurality of product review contents, where N is a positive integer (e.g., the product review contents having the five highest confidence values). In some example embodiments, the data generation system 150 uses a confidence value threshold to filter out from selection any product review content that has a confidence value that does not meet the confidence value threshold. In some example embodiments, the selecting of the portion of the identified subset of product review contents comprises determining an order in which to display the portion of the identified subset of product review contents based on a model. The order may be inconsistent with the confidence values of the subset of product review contents, such that the selected product review contents are not ordered strictly according to their confidence values. For example, the first product review content to be displayed in the product description will not necessarily be the product review content with the highest or the lowest confidence value.

At operation 1040, the data generation system 150 causes the selected portion of the identified subset of product review contents to be displayed on a client device in a user interface area 410 dedicated for the product description of the product.

It is contemplated that the operations of method 1000 can incorporate any of the other features disclosed herein.

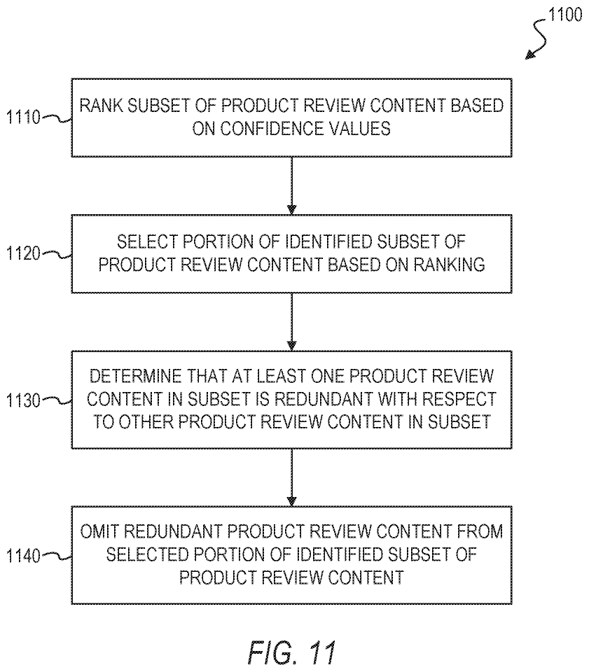

FIG. 11 is a flowchart illustrating a method 1100 of selecting at least a portion of an identified subset of product review content for inclusion in a product description for a product, in accordance with some example embodiments. The operations of method 1100 can be performed by a system or modules of a system. The operations of method 1100 can be performed by processing logic that can comprise hardware (e.g., circuitry, dedicated logic, programmable logic, microcode, etc.), software (e.g., instructions run on a processing device), or a combination thereof. In one example embodiment, the method 1100 is performed by data generation system 150 of FIGS. 1 and 5, or any combination of one or more of its components or modules, as described above.

At operation 1110, the data generation system 150 ranks the subset of product review contents based on the confidence values of the subset of product review contents. At operation 1120, the data generation system 150 selects at least a portion of the identified subset of product review content based on the ranking. At operation 1130, the data generation system 150 determines that at least one of the product review contents in the subset of product review contents is redundant with respect to another product review content in the subset of product review contents based on a comparison of the product review content in the subset with other product review contents in the subset. At operation 1140, the data generation system 150 omits the product review content from the selected portion of the identified subset of product review content based on the determination that the product review content is redundant.

It is contemplated that the operations of method 1100 can incorporate any of the other features disclosed herein.

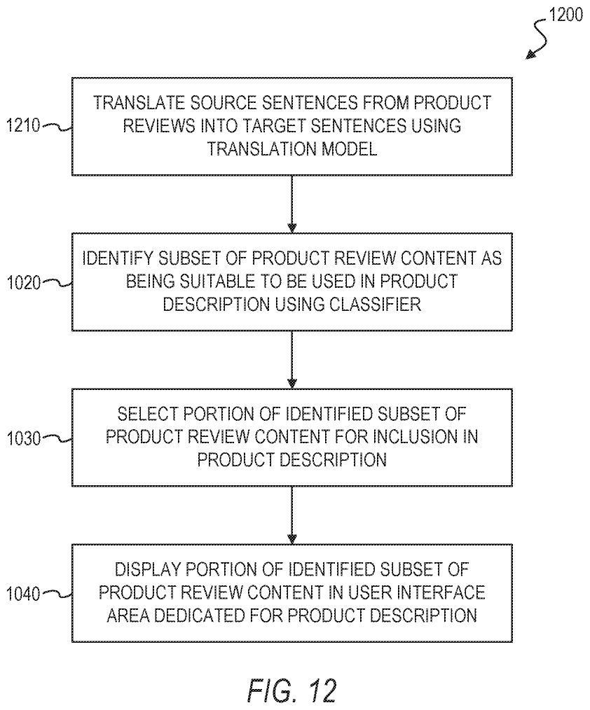

FIG. 12 is a flowchart illustrating a method 1200 of generating a product description from product reviews, in accordance with some example embodiments. The operations of method 1200 can be performed by a system or modules of a system. The operations of method 1200 can be performed by processing logic that can comprise hardware (e.g., circuitry, dedicated logic, programmable logic, microcode, etc.), software (e.g., instructions run on a processing device), or a combination thereof. In one example embodiment, the method 1200 is performed by data generation system 150 of FIGS. 1 and 5, or any combination of one or more of its components or modules, as described above.

The method 1200 comprises operation 1210 being performed prior to the performance of operation 1020 of the method 1000 in FIG. 1000. At operation 1210, the data generation system 150 receives a plurality of source sentences from product reviews, and then translates each one of the plurality of source sentences into a corresponding target sentence using a translation model. The plurality of product review content used in operation 1020 comprises the target sentences corresponding to the plurality of source sentences.

It is contemplated that the operations of method 1200 can incorporate any of the other features disclosed herein.

It is contemplated that any features of any embodiments disclosed herein can be combined with any other features of any other embodiments disclosed herein. Accordingly, any such hybrid embodiments are within the scope of the present disclosure.

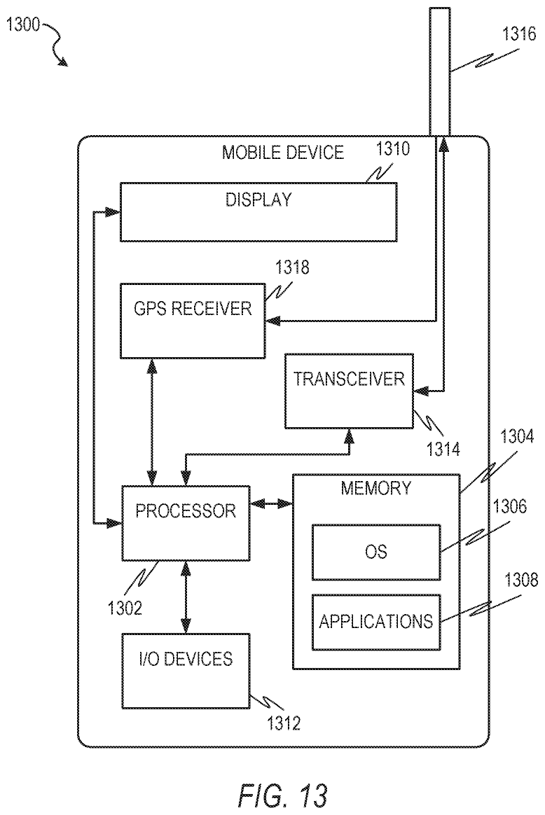

FIG. 13 is a block diagram illustrating a mobile device 1300, in accordance with some example embodiments. The mobile device 1300 can include a processor 1302. The processor 1302 can be any of a variety of different types of commercially available processors suitable for mobile devices 1300 (for example, an XScale architecture microprocessor, a Microprocessor without Interlocked Pipeline Stages (MIPS) architecture processor, or another type of processor). A memory 1304, such as a random access memory (RAM), a Flash memory, or other type of memory, is typically accessible to the processor 1302. The memory 1304 can be adapted to store an operating system (OS) 1306, as well as application programs 1308, such as a mobile location enabled application that can provide LBSs to a user. The processor 1302 can be coupled, either directly or via appropriate intermediary hardware, to a display 1310 and to one or more input/output (I/O) devices 1312, such as a keypad, a touch panel sensor, a microphone, and the like. Similarly, in some example embodiments, the processor 1302 can be coupled to a transceiver 1314 that interfaces with an antenna 1316. The transceiver 1314 can be configured to both transmit and receive cellular network signals, wireless data signals, or other types of signals via the antenna 1316, depending on the nature of the mobile device 1300. Further, in some configurations, a GPS receiver 1318 can also make use of the antenna 1316 to receive GPS signals.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 1-12 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the features of the present disclosure in different contexts from the disclosure contained herein.

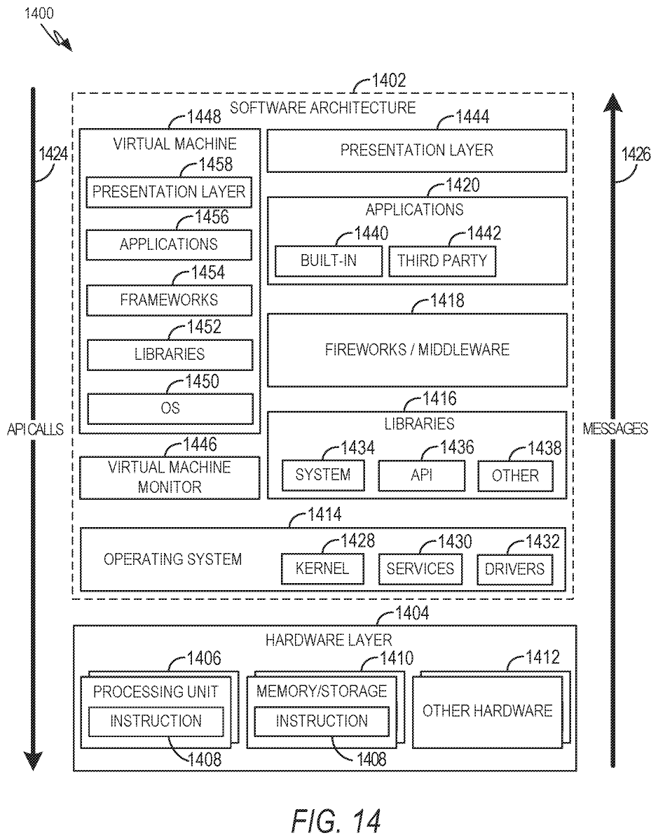

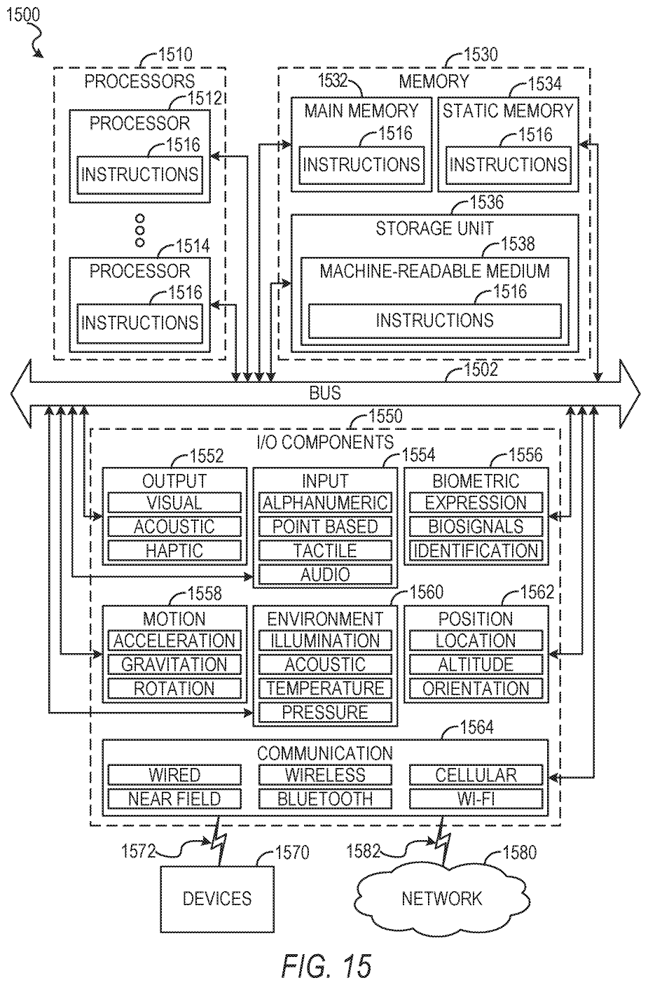

FIG. 14 is a block diagram 1400 illustrating a representative software architecture 1402, which may be used in conjunction with various hardware architectures herein described. FIG. 14 is merely a non-limiting example of a software architecture 1402 and it will be appreciated that many other architectures may be implemented to facilitate the functionality described herein. The software architecture 1402 may be executing on hardware such as a machine 1500 of FIG. 15 that includes, among other things, processors 1510, memory/storage 1530, and I/O components 1550. A representative hardware layer 1404 is illustrated in FIG. 14 and can represent, for example, the machine 1500 of FIG. 15. The representative hardware layer 1404 comprises one or more processing units 1406 having associated executable instructions 1408. The executable instructions 1408 represent the executable instructions of the software architecture 1402, including implementation of the methods, modules, and features disclosed above with respect to FIGS. 1-12. The hardware layer 1404 also includes memory and/or storage modules 1410, which also have the executable instructions 1408. The hardware layer 1404 may also comprise other hardware 1412, which represents any other hardware of the hardware layer 1404, such as the other hardware illustrated as part of the machine 1500.

In the example architecture of FIG. 14, the software architecture 1402 may be conceptualized as a stack of layers where each layer provides particular functionality. For example, the software architecture 1402 may include layers such as an operating system 1414, libraries 1416, frameworks/middleware 1418, applications 1420, and a presentation layer 1444. Operationally, the applications 1420 and/or other components within the layers may invoke application programming interface (API) calls 1424 through the software stack and receive a response, returned values, and so forth, illustrated as messages 1426, in response to the API calls 1424. The layers illustrated are representative in nature and not all software architectures have all layers. For example, some mobile or special purpose operating systems may not provide a frameworks/middleware 1418, while others may provide such a layer. Other software architectures may include additional or different layers.

The operating system 1414 may manage hardware resources and provide common services. The operating system 1414 may include, for example, a kernel 1428, services 1430, and drivers 1432. The kernel 1428 may act as an abstraction layer between the hardware and the other software layers. For example, the kernel 1428 may be responsible for memory management, processor management (e.g., scheduling), component management, networking, security settings, and so on. The services 1430 may provide other common services for the other software layers. The drivers 1432 may be responsible for controlling or interfacing with the underlying hardware. For instance, the drivers 1432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1416 may provide a common infrastructure that may be utilized by the applications 1420 or other components or layers. The libraries 1416 typically provide functionality that allows other software modules to perform tasks in an easier fashion than to interface directly with the underlying operating system 1414 functionality (e.g., kernel 1428, services 1430, and/or drivers 1432). The libraries 1416 may include system libraries 1434 (e.g., C standard library) that may provide functions such as memory allocation functions, string manipulation functions, mathematic functions, and the like. In addition, the libraries 1416 may include API libraries 1436 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1416 may also include a wide variety of other libraries 1438 to provide many other APIs to the applications 1420 and other software components/modules.

The frameworks/middleware 1418 may provide a higher-level common infrastructure that may be utilized by the applications 1420 or other software components/modules. For example, the frameworks/middleware 1418 may provide various graphic user interface (GUI) functions, high-level resource management, high-level location services, and so forth. The frameworks/middleware 1418 may provide a broad spectrum of other APIs that may be utilized by the applications 1420 or other software components/modules, some of which may be specific to a particular operating system or platform.

The applications 1420 include built-in applications 1440 or third party applications 1442. Examples of representative built-in applications 1440 may include, but are not limited to, a contacts application, a browser application, a book reader application, a location application, a media application, a messaging application, or a game application. The third party applications 1442 may include any of the built in applications 1440 as well as a broad assortment of other applications. In a specific example, the third party application 1442 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1442 may invoke the API calls 1424 provided by the mobile operating system such as the operating system 1414 to facilitate functionality described herein.

The applications 1420 may utilize built-in operating system functions (e.g., kernel 1428, services 1430, and/or drivers 1432), libraries (e.g., system libraries 1434, API libraries 1436, and other libraries 1438), and frameworks/middleware 1418 to create user interfaces to interact with users of the system. Alternatively, or additionally, in some systems, interactions with a user may occur through a presentation layer, such as the presentation layer 1444. In these systems, the application/module “logic” can be separated from the aspects of the application/module that interact with a user.

Some software architectures utilize virtual machines. In the example of FIG. 14, this is illustrated by a virtual machine 1448. A virtual machine creates a software environment where applications/modules can execute as if they were executing on a hardware machine (e.g., the machine of FIG. 15). A virtual machine is hosted by a host operating system (e.g., operating system 1414) and typically, although not always, has a virtual machine monitor 1446, which manages the operation of the virtual machine 1448 as well as the interface with the host operating system (e.g., operating system 1414). A software architecture executes within the virtual machine 1448 such as an operating system 1450, libraries 1452, frameworks 1454, applications 1456, or presentation layer 1458. These layers of software architecture executing within the virtual machine 1448 can be the same as corresponding layers previously described or may be different.

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. For example the instructions may cause the machine 1500 to execute any one of the respective methods 1000, 1100, and 1200 of FIGS. 10, 11, and 12. Additionally, or alternatively, the instructions 1516 may implement any combination of one or more of the modules of FIG. 6, and so forth. The instructions 1516 transform the general, non-programmed machine into a particular machine programmed to carry out the described and illustrated functions in the manner described. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1516, sequentially or otherwise, that specify actions to be taken by machine 1500. Further, while only a single machine 1500 is illustrated, the term “machine” shall also be taken to include a collection of machines 1500 that individually or jointly execute the instructions 1516 to perform any one or more of the methodologies discussed herein.

The machine 1500 may include processors 1510, memory 1530, and I/O components 1550, which may be configured to communicate with each other such as via a bus 1502. In an example embodiment, the processors 1510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1512 and processor 1514 that may execute instructions 1516. The term “processor” is intended to include multi-core processor that may comprise two or more independent processors (sometimes referred to as “cores”) that may execute instructions contemporaneously. Although FIG. 15 shows multiple processors 1510, the machine 1500 may include a single processor with a single core, a single processor with multiple cores (e.g., a multi-core process), multiple processors with a single core, multiple processors with multiples cores, or any combination thereof.

The memory/storage 1530 may include a memory 1532, such as a main memory, or other memory storage, and a storage unit 1536, both accessible to the processors 1510 such as via the bus 1502. The storage unit 1536 and memory 1532 store the instructions 1516 embodying any one or more of the methodologies or functions described herein. The instructions 1516 may also reside, completely or partially, within the memory 1532, within the storage unit 1536, within at least one of the processors 1510 (e.g., within the processor's cache memory), or any suitable combination thereof, during execution thereof by the machine 1500. Accordingly, the memory 1532, the storage unit 1536, and the memory of processors 1510 are examples of machine-readable media.

As used herein, “machine-readable medium” means a device able to store or carry instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1516. The term “machine-readable medium” shall also be taken to include any medium, or combination of multiple media, that is capable of storing or carrying instructions (e.g., instructions 1516) for execution by a machine (e.g., machine 1500), such that the instructions, when executed by one or more processors of the machine 1500 (e.g., processors 1510), cause the machine 1500 to perform any one or more of the methodologies described herein. Accordingly, a “machine-readable storage medium” refers to a single storage apparatus or device, as well as “cloud-based” storage systems or storage networks that include multiple storage apparatus or devices. The term “machine-readable medium” includes transmission media such as signals.

The I/O components 1550 may include a wide variety of components to receive input, provide output, produce output, transmit information, exchange information, capture measurements, and so on. The specific I/O components 1550 that are included in a particular machine will depend on the type of machine. For example, portable machines such as mobile phones will likely include a touch input device or other such input mechanisms, while a headless server machine will likely not include such a touch input device. It will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 may include output components 1552 and input components 1554. The output components 1552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1550 may include biometric components 1556, motion components 1558, environmental components 1560, or position components 1562 among a wide array of other components. For example, the biometric components 1556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1558 may include acceleration sensor components (e.g., accelerometer), gravitation sensor components, rotation sensor components (e.g., gyroscope), and so forth. The environmental components 1560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1550 may include communication components 1564 operable to couple the machine 1500 to a network 1580 or devices 1570 via coupling 1582 and coupling 1572 respectively. For example, the communication components 1564 may include a network interface component or other suitable device to interface with the network 1580. In further examples, communication components 1564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1570 may be another machine or any of a wide variety of peripheral devices (e.g., a peripheral device coupled via a Universal Serial Bus (USB)).

Moreover, the communication components 1564 may detect identifiers or include components operable to detect identifiers. For example, the communication components 1564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1564, such as, location via Internet Protocol (IP) geo-location, location via Wi-Fi® signal triangulation, location via detecting a NFC beacon signal that may indicate a particular location, and so forth.

In various example embodiments, one or more portions of the network 1580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network and the coupling 1582 may be a Code Division Multiple Access (CDMA) connection, a Global System for Mobile communications (GSM) connection, or other type of cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1516 may be transmitted or received over the network 1580 using a transmission medium via a network interface device (e.g., a network interface component included in the communication components 1564) and utilizing any one of a number of well-known transfer protocols (e.g., hypertext transfer protocol (HTTP)). Similarly, the instructions 1516 may be transmitted or received using a transmission medium via the coupling 1572 (e.g., a peer-to-peer coupling) to devices 1570. The term “transmission medium” shall be taken to include any computer-readable medium that is capable of encoding or carrying instructions 1516 for execution by the machine 1500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
identifying, by one or more hardware processors, a subset of product review contents from amongst a plurality of product review contents as being suitable to be used in a product description for a product using a classifier, the classifier predicting each product review content in the subset to be suitable to be used in the product description with a corresponding confidence value;
selecting, by the one or more hardware processors, at least a portion of the identified subset of product review contents for inclusion in the product description for the product, the selecting the at least a portion of the identified subset of product review contents comprising:
ranking the subset of product review contents based on the confidence values of the subset of product review contents; and
selecting the at least a portion of the identified subset of product review contents based on the ranking; and
causing, by the one or more hardware processors, the at least a portion of the identified subset of product review contents to be displayed on a client device in a user interface area dedicated for the product description of the product.

2. The computer-implemented method of claim 1, wherein the selecting the at least a portion of the identified subset of product review contents further comprises:
determining that at least one of the product review contents in the subset of product review contents is to be omitted from inclusion in the selected portion of the identified subset of product review contents to be displayed in the user interface area dedicated for the product description of the product, the determining that the at least one of the product review contents in the subset of product review contents is to be omitted from inclusion being based on at least one factor; and
omitting the at least one of the product review contents from the selected portion of the identified subset of product review contents based on the determining that the at least one of the product review contents is to be omitted.

3. The computer-implemented method of claim 2, wherein the at least one factor comprises a determination that the at least one of the product review contents in the subset of product review contents is redundant with respect to another product review content in the subset of product review contents based on a comparison of the at least one of the product review contents in the subset with other product review content in the subset.

4. The computer-implemented method of claim 1, wherein the selecting the at least a portion of the identified subset of product review contents comprises determining an order in which to display the at least a portion of the identified subset of product review contents based on a model, the order being inconsistent with the ranking of the subset of product review contents.

5. The computer-implemented method of claim 1, wherein the identifying the subset of product review contents comprises:
receiving a plurality of source sentences from product reviews; and
translating each one of the plurality of source sentences into a corresponding target sentence using a translation model, the plurality of product review content comprising the target sentences corresponding to the plurality of source sentences.

6. The computer-implemented method of claim 5, wherein the selecting of the at least a portion of the identified subset of product review contents for inclusion in the product description for the product is based on at least one of:
for each one of the plurality of source sentences and its corresponding target sentence, a degree of change between the source sentence and the target sentence;
for each one of the plurality of source sentences and its corresponding target sentence, one or more words that were removed in the translating of the source sentence into the target sentence;
for each one of the plurality of source sentences and its corresponding target sentence, one or more words that were added in the translating of the source sentence into the target sentence; and
for each one of the plurality of source sentences and its corresponding target sentence, a confidence score for the translating of the source sentence into the target sentence.

7. The computer-implemented method of claim 1, wherein the selecting of the at least a portion of the identified subset of product review contents is based on one or more characteristics of the client device.

8. The computer-implemented method of claim 7, wherein the one or more characteristics comprises a screen size of the client device.

9. The computer-implemented method of claim 1, wherein each product review content in the plurality of product review contents comprises a sentence.

10. The computer-implemented method of claim 1, further comprising training, by the one or more hardware processors, the classifier using another plurality of product review contents as training data, a portion of the other plurality of product review contents being identified as being suitable for use in product description and a remaining portion of the other plurality of product review contents being identified as being unsuitable for use in product descriptions.

11. A system comprising:
at least one hardware processor; and
a computer-readable storage medium storing executable instructions that, when executed, cause the at least one hardware processor to perform operations comprising:
identifying a subset of product review contents from amongst a plurality of product review contents as being suitable to be used in a product description for a product using a classifier, the classifier predicting each product review content in the subset to be suitable to be used in the product description with a corresponding confidence value;
selecting at least a portion of the identified subset of product review contents for inclusion in the product description for the product based on the corresponding confidence values of the selected at least a portion of the identified subset of product review contents; and
causing the at least a portion of the identified subset of product review contents to be displayed on a client device in a user interface area dedicated for the product description of the product.

12. The system of claim 11, wherein the selecting the at least a portion of the identified subset of product review contents comprises:
ranking the subset of product review contents based on the confidence values of the subset of product review contents; and
selecting the at least a portion of the identified subset of product review contents based on the ranking.

13. The system of claim 11, wherein the selecting the at least a portion of the identified subset of product review contents comprises:
determining that at least one of the product review contents in the subset of product review contents is redundant with respect to another product review contents in the subset of product review content based on a comparison of the at least one of the product review contents in the subset with other product review contents in the subset, and
omitting the at least one of the product review contents from the selected portion of the identified subset of product review contents based on the determination that the at least one of the product review contents is redundant.

14. The system of claim 11, wherein the selecting the at least a portion of the identified subset of product review contents comprises determining an order in which to display the at least a portion of the identified subset of product review contents based on a model, the order being inconsistent with the ranking of the subset of product review contents.

15. The system of claim 11, wherein the identifying the subset of product review contents comprises:
receiving a plurality of source sentences from product reviews; and
translating each one of the plurality of source sentences into a corresponding target sentence using a translation model, the plurality of product review content comprising the target sentences corresponding to the plurality of source sentences.

16. The system of claim 15, wherein the selecting of the at least a portion of the identified subset of product review contents for inclusion in the product description for the product is based on at least one of:
for each one of the plurality of source sentences and its corresponding target sentence, a degree of change between the source sentence and the target sentence;
for each one of the plurality of source sentences and its corresponding target sentence, one or more words that were removed in the translating of the source sentence into the target sentence;
for each one of the plurality of source sentences and its corresponding target sentence, one or more words that were added in the translating of the source sentence into the target sentence; and
for each one of the plurality of source sentences and its corresponding target sentence, a confidence score for the translating of the source sentence into the target sentence.

17. The system of claim 11, wherein the selecting of the at least a portion of the identified subset of product review contents is based on one or more characteristics of the client device.

18. The system of claim 17, wherein the one or more characteristics comprises a screen size of the client device.

19. The system of claim 11, wherein the operations further comprise training the classifier using another plurality of product review contents as training data, a portion of the other plurality of product review contents being identified as being suitable for use in product description and a remaining portion of the other plurality of product review contents being identified as being unsuitable for use in product descriptions.

20. A machine-readable storage medium storing a set of instructions that, when executed by at least one processor, causes the at least one processor to perform operations comprising:
identifying a subset of product review contents from amongst a plurality of product review contents as being suitable to be used in a product description for a product using a classifier, the classifier predicting each product review content in the subset to be suitable to be used in the product description with a corresponding confidence value;
selecting at least a portion of the identified subset of product review contents for inclusion in the product description for the product based on the corresponding confidence values of the selected at least a portion of the identified subset of product review contents; and
causing the at least a portion of the identified subset of product review contents to be displayed on a client device in a user interface area dedicated for the product description of the product.
